(19) United States
(12) Patent Application Publication
(10) Pub. No.: US 2008/0243847 A1
(43) Pub. Date: Oct. 2, 2008

(54) Separating central locking services from distributed data fulfillment services in a storage system

(75) Inventor: David J. Rasmussen, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/732,042

(22) Filed: Apr. 2, 2007

(51) Int. Cl. G06F 17/30

(52) U.S. Cl. 707/8; 707/E17.007

(57) ABSTRACT

Techniques for implementing locking semantics for a storage system are described. An apparatus or system may include a data server to store multiple data files, and a locking server to store locking information for one or more data files stored by the data server. The locking information may include a version number for a data file and a lock state for the data file. Other embodiments are described and claimed.

### RELATED CASE

The present application is related to commonly owned U.S. patent application Ser. No. ______ filed on even date titled “Locking Semantics For A Storage System Based on File Types” having matter reference number M319355.01, the entirety of which is hereby incorporated by reference.

### BACKGROUND

Network storage systems and storage area networks (SAN) have developed in response to the increasing proliferation of data requirements and web services. Network storage systems generally focus on the storage, protection and retrieval of data in large-scale environments. Such massive network storage systems are sometimes referred to as mass cloud storage systems, which is a term that is used to refer to large-scale storage systems having multiple servers and infrastructure to provide various types of network services to a host of client devices. With such massive scales, bandwidth often becomes an increasingly scarce resource typically in direct proportion to the number of client devices attempting to use the services provided by the given mass cloud storage system. Consequently, techniques for improved bandwidth utilization and efficiency may be desirable for network storage systems, devices and users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments may be generally directed to network storage systems. Some embodiments may be particularly directed to improved techniques for implementing novel locking semantics for a network storage system. A network storage system may be arranged to utilize the locking semantics to reduce network traffic between client devices and the equipment used to implement the network storage system, such as server arrays, network appliances, routers, switches and so forth. In this manner, the embodiments may improve bandwidth utilization and efficiency for a network or device.

In one embodiment, for example, an apparatus such as a network storage system may include one or more data servers arranged to store multiple data files of various types. The network storage system may further include one or more locking servers arranged to store locking information for one or more of the data files stored by the data servers. The locking information may include, for example, a version number for a data file, a lock state for the data file, a client identifier (ID) if the data file has been previously locked, and so forth. By distributing locking operations and data storage operations into different server arrays or clusters, various client devices may access locking services and data management services in a more efficient manner. Other embodiments are described and claimed.

### BRIEF DESCRIPTION OF THE DRAWINGS

FIG. 1 illustrates one embodiment of a network storage system.

FIG. 2 illustrates one embodiment of a logic flow.

FIG. 3 illustrates one embodiment of a computing system architecture.

### DETAILED DESCRIPTION

Various embodiments may comprise one or more elements. An element may comprise any feature, characteristic, structure or operation described in connection with an embodiment. Examples of elements may include hardware elements, software elements, physical elements, or any combination thereof. Although an embodiment may be described with a limited number of elements in a certain arrangement by way of example, the embodiment may include more or less elements in alternate arrangements as desired for a given implementation. It is worthy to note that any references to “one embodiment” or “an embodiment” are not necessarily referring to the same embodiment.

Various embodiments may be directed to improved techniques for implementing novel locking semantics for a network storage system. For example, some embodiments may increase the efficiency and scalability of a network storage system by separating locking operations and data management operations into different server clusters of a server array or server farm. This facilitates scaling of the network services since bandwidth requirements to the respective server clusters can be lowered.

In various embodiments, a network storage system architecture may be implemented to separate locking services from data services that can be provided by a server or peer mesh to facilitate massive scaling. In one embodiment, for example, a network storage system may include one or more locking servers arranged to store locking information for one or more of data files stored by a set of data servers or client devices. The locking servers may be arranged to implement locking provisioning and data synchronization operations. When granting a write lock to a client device, the locking server and the client device need at least two pieces of information: (1) that no other client device has the write lock; and (2) the requesting client device has the latest revision of the file from the last write operation. If the requesting client device does not have the latest revision of the target file, then the client is synchronized to this revision before the lock is granted. The second condition does not necessarily require that the locking server be the provider of the bits to get the requesting client device up-to-date. In fact, the second condition does not necessarily require the locking server to store the data file at all.

The locking servers may manage lock operations for the various client devices and file versions using a unique file identifier. Each version of a data file has an associated ID referred to as a globally unique identifier (GUID). The locking server stores the GUID for the latest revision of a data file along with the current state of the lock. The lock state information may indicate, for example, whether the file is currently locked, and if so by which client device. If a client device does not yet have this revision, it triggers synchronization operations to get this revision from one or more of its peers that have the particular revision, or a central data server (not necessarily the locking server) in the absence of available peers. Once the client device is in synchronization then the lock can be granted. When a client has completed a write operation it contacts the locking server to release the lock, and provides a new GUID that represents the current revision of the file. The client device also stores the new GUID along with the revised data file. It is replicated along with the file. In this manner, the locking servers may manage locking operations for a relatively large number of client devices, while reducing associated bandwidth requirements.

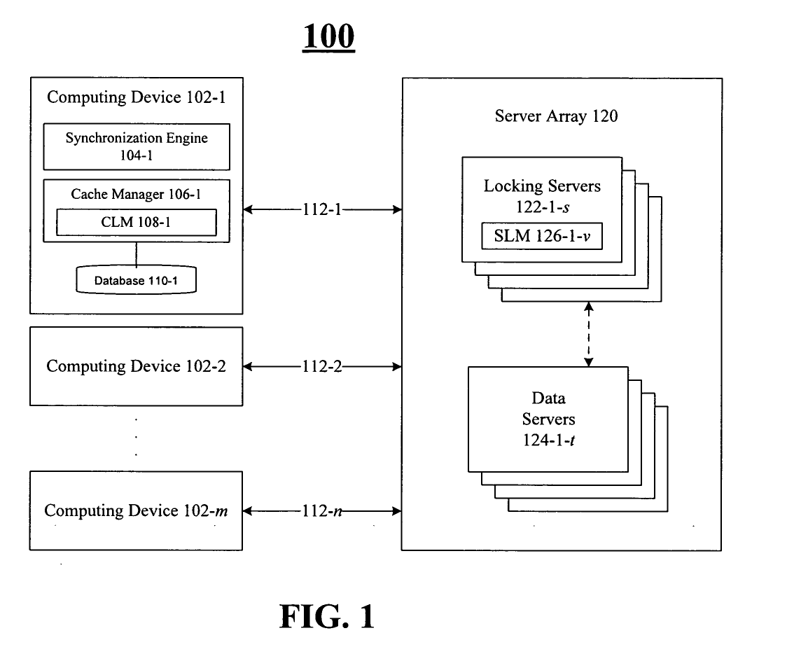

FIG. 1 illustrates a block diagram of a network storage system 100. The network storage system 100 may represent a wired or wireless communication system. As shown in FIG. 1, one embodiment of the network storage system 100 may include one or more client devices 102-1-m communicatively coupled to a server array 120 via one or more wired or wireless connections 112-1-m. The server array 120 may include one or more locking servers 122-1-s and one or more data servers 124-1-t. In some implementations, the locking servers 122-1-s and data servers 124-1-t may be communicatively coupled, and in others the locking servers 122-1-s and data servers 124-1-t may be completely separate with no connectivity. Each of the client devices 102-1-m may include various other elements. As shown in the exploded view of the representative client device 102-1, for example, each of the client devices 102-1-m may include a synchronization engine 104-1-m, a cache manager 106-1-m, a client lock manager 108-1-m, and a database 110-1-m.

In various embodiments, the network storage system 100 may include the server array 120. The server array 120 may comprise multiple servers and other network infrastructure for providing network storage services or mass cloud storage services for the client devices 102-1-m. In one embodiment, for example, the server array 120 may be implemented as a server farm. A server farm is a collection of computer servers usually maintained by an enterprise to accomplish server needs far beyond the capability of one machine. Server farms are typically co-located with the network switches and/or routers which enable communication between the different parts of the cluster and the users of the cluster. Server farms are commonly used for large-scale computing operations, such as cluster computing, web hosting, web services, massive parallel processing operations, and so forth. Because of the sheer number of computers in larger server farms the failure of individual machines is a commonplace event, and therefore management of large server farms typically provide support for redundancy, automatic failover, and rapid reconfiguration of the server cluster.

In various embodiments, mass cloud storage systems and techniques may be applicable for large scale network storage systems implemented as storage area networks (SAN). Further, mass cloud storage systems and techniques may be implemented as storage systems provided over a packet network (such as the Internet) via a Wide Area Network (WAN) and across large geographies into massive hosted data centers. Mass cloud storage systems generally provide storage services to consumers, clients or operators on the order of millions or more. These would typically be publicly available commercial storage services.

The mass cloud storage services provided by the server array 120 may be implemented for various use scenarios. For example, the server array 120 may be used to implement user state portability where a single operator utilizes multiple devices. User state portability allows for shared state and/or data across multiple user machines and devices, backup and restore operations, machine migration services, roaming state when logged into “public” machines, and so forth. In another example, the server array 120 may be used to implement data sharing operations where there is a single author and multiple readers or consumers. Data sharing operations may be desirable when a single author shares multimedia information (e.g., photos, music, videos, etc.) with others, or for personal publishing (e.g., web site, blogs, podcasting, etc.). In yet another example, the server array 120 may be used to support collaboration efforts involving multiple authors. Collaboration efforts may include multi-user content creation/editing.

To support these and other scenarios, the server array 120 may communicate information with the client devices 102-1-m via the wired or wireless connections 112-1-n, where shared data is cached locally on each of the client devices 102-1-m. A file system driver may be implemented for each of the client devices 102-1-m to handle redirection to the local cache and populating it from the mass cloud storage service such that any application programs above it need not be aware of the specifics of the service and require no knowledge of the underlying data synchronization operations.

In one embodiment, for example, the client device 102-1 illustrates a synchronization engine 104-1 and a cache manager 106-1 to perform data synchronization operations between the client device 102-1 and the server array 120. In this manner, the client devices 102-1-m may take advantage of any centralized services provided by the server array 120, such as discovery operations, seeding operations, locking operations, and so forth. The synchronization engine 104-1 and the cache manager 106-1 may also perform peer-to-peer data synchronization operations between the client device 102-1 and the other client devices 102-2-m. The peer-to-peer data synchronization operations may be useful for scale efficiency, which may be particularly important due to the larger number of devices implemented for the network storage system 100.

In various embodiments, the network storage system 100 may implement various techniques for performing cache consistency and locking operations. Maintaining cache consistency in a mass cloud storage environment, however, can be quite challenging. In a multi-client scenario, one or more operators may create or edit data files on multiple client devices 102-1-m. In some cases, multiple operators may create or edit data files potentially simultaneously or between synchronization operations. Further, the client devices 102-1-m may not always be able to access each other for various reasons, such as lack of network connectivity, device powered off, and so forth.

System designs for distributed or cached file systems can address this challenge in various ways. For example, data files may be treated as immutable where the data files are never changed, and modification of an existing file just adds a new forked copy of the original file. There are only file additions and deletions in this case. In another example, different versions of the same data file may be merged on behalf of an application program. In this case, the platform is aware of a file format for the data file and uses this knowledge to merge the data files at synchronization time if the data file has been modified in two places. In yet another example, customized or application specific merge operations may be performed for different versions of the same data file. When the platform detects a file conflict, it calls a format specific merge provider registered by the owning app. In still another example, a centralized file locking technique may be implemented. The platform provides centralized file locking, so that only one device can write at a time and must be in synchronization prior to write operations. Readers can be out of date, but writers never unknowingly write over each other.

Each of these cache consistency solutions, however, has associated limitations. For example, merging data files at synchronization time by the platform may be impractical for the network storage system 100 due to the large-scale implementation size. They are impractical because they either require the providers of the platform technology to be aware of every possible file format and engineer suitable merging algorithms, or they require each application developer to write a merge provider that complies with that synchronization platform. Writing merge algorithms that converge well with multiple peers is very difficult. So it is highly unlikely that application developers will write merge providers for all the potentially different file formats. With respect to treating files as immutable, this solution may be appropriate for a narrow set of scenarios, but may create undesired results when applied universally. If the platform encounters a conflict for immutable files, it forks the file into two separate files. Once the file is forked it can be very difficult for the user to merge and resolve, thereby leading to something that feels equivalent to data loss for the user. This approach may be suitable if conflicts are infrequent, such as when users do not actively use files on more than one machine and they are careful when transitioning between machines, but may be unsuitable for active users with multiple machines. This approach is not suitable, however, for files that are modified relatively often by an application program, such as files for MICROSOFT® OUTLOOK® or MICROSOFT ONENOTE, for example. Forcing a user to repeatedly reconcile two copies of these files may be undesirable from a user perspective, and in some cases, is sometimes impossible. This problem compounds significantly with multiple users. If a service used this approach it would either need to significantly restrict user scenarios or expect a very poor user experience and subsequent loss of user trust. In either case this would limit business success.

Centralized locking provides several advantages for maintaining cache consistency, although it has some associated disadvantages as well. Some disadvantages include difficulty in scaling, especially if centralized locking is tied to centralized storage and access of the actual data. Another challenge is how users can modify data when not connected to the centralized server. A benefit of centralized locking, however, is that applications do not need to be rewritten. Existing applications are designed to work with locks on network file storage. Some application programs, such as MICROSOFT WORD, provide a read-only copy of the file to other users if another client already has a write lock. Other application programs, such as MICROSOFT ONENOTE, use locking techniques to manage merging of changes among multiple clients. In both cases, the application developer and the user experience is familiar and understood. But not all scenarios and file types require centralized locking support. The requirements are somewhat specific to the scenario and file type.

In various embodiments, massive scale for the network storage system 100 could be feasibly achieved by separating locking operations from the data storage operations thereby distributing user loads for the server array 102. In some embodiments, the server array 120 may provide various centralized services to the client devices 102-1-m, such as data storage operations and data file locking operations for the client devices 102-1-m. To increase efficient delivery of these services, the server array 120 may implement each class of operations in different server clusters. As shown in FIG. 1, for example, the server array 120 may include one or more locking servers 122-1-s, and one or more data servers 124-1-t. By distributing locking operations and data storage operations into different server arrays or clusters, various client devices may access locking services and data management services in a more efficient manner.

In various embodiments, the data servers 124-1-t may be arranged to perform various shared data storage or distributed file management operations for information or data operated on by the client devices 102-1-m. For example, the data servers 124-1-t may be arranged to store multiple data files or records of various types. The term data files may include any discrete set of information or data stored by an electronic device. Examples of data files may include word processing documents, spreadsheet documents, multimedia files (e.g., audio, video, images, photographs, etc.), and so forth. The data files may be periodically synchronized with local copies of the data files stored by the client devices 102-1-m, such as in the database 110-1 as managed by the cache manager 106-1 of the client device 102-1, for example.

In various embodiments, the locking servers 122-1-s may be arranged to perform various locking operations for the client devices 102-1-m. For example, the locking servers 122-1-s may be arranged to store locking information for one or more of the data files stored by the data servers 124-1-t. The locking information may include without limitation, for example, a version number for a data file, a lock state for the data file, a client ID if the data file has been previously locked, general locking semantics or rules for the client devices 102-1-m, unique locking semantics or rules for certain of the client devices 102-1-m, and so forth. Although the various embodiments in general, and the locking servers 122-1-s in particular, may be described as implementing locking semantics or rules for basic read and write locks for a data file, it may be appreciated the embodiments may be implemented for other type of locks or permissions that could be granted to different client devices. For example, the locking semantics may be similarly applied to security operations, authentication operations, controlled user access, and so forth. The embodiments are not limited in this context.

In various embodiments, the locking servers 122-1-s may each include respective server lock managers 126-1-v. The server lock managers 126-1-v may be arranged to interact with the client lock managers 108-1-m to manage lock operations for data files stored by the client devices 102-1-m and/or the data servers 124-1-t. The lock operations may include locking a data file for read operations, write operations, read/write operations, and so forth.

In various embodiments, the lock operations may be implemented using unique identifiers for each version of a data file. In one embodiment, for example, a server lock manager 126-1-v may store a first identifier for a data file. The first identifier may comprise an identifier representing a most current version for the data file known by the server lock manager 126-1-v. Assume a client device 102-1-m desires to modify a local version of the data file stored by the respective database 110-1-m. The client lock manager 108-1-m of the cache manager 106-1-m that manages the local version of data file may send a lock request to lock the data file with a second identifier for the data file to the locking servers 122-1-s. The server lock manager 126-1-v may receive the lock request to lock the data file with the second identifier from a client device 102-1-m. The second identifier may comprise an identifier representing a most current version for the data file known by the client lock manager 108-1-m. The server lock manager 126-1-v may compare the first identifier with the second identifier, and send a lock request response to the client lock manager 108-1-m. The lock request response may have control information granting the lock request if the first and second identifiers match, and denying the lock request if the first and second identifiers do not match.

If the first and second identifiers fail to match, then the server lock manager 126-1-v may also include instructions to retrieve an updated version of the data file in the lock request response sent to the client device 102-1-m. The client device 102-1-m receives a lock request response granting the lock request or denying the lock request based on the first identifier from the locking server 122-1-s. If the client device 102-1-m receives the lock request response indicating the previous lock request has been denied by the server array 120, the lock request response may also include control information indicating that a local version of the data file stored in the database 110-1-m of the client device 102-1-m is not the most current version of the data file for which the lock request was denied. The synchronization engine 104-1-m of the respective client device 102-1-m may synchronize the local version of a data file with a server version of the data file stored by the data servers 124-1-t in response to instructions received from the locking server. Alternatively, the synchronization engine 104-1-m of the respective client device 102-1-m may synchronize the local version of a data file with another local version of the data file stored by another client device 102-1-m using a peer-to-peer distributed file management technique. Once the client device 102-1-m has the most current version of a data file, then the locking server 122-1-s may grant the write lock to the client device 102-1-m.

By way of example, assume that the network storage system 100 is a mass cloud storage system arranged to implement locking provisioning and data synchronization operations for a relatively large number of client devices. When granting a write lock to a client device 102-1-m, the locking server 122-1-s and the client device 102-1-m need at least two pieces of information: (1) that no other client device has the write lock; and (2) the requesting client device has the latest revision of the file from the last write operation. If the second condition is not met, then the client needs to be synchronized to this revision before the lock can be granted. It may be appreciated that the second condition does not necessarily require that the lock server 122-1-s be the provider of the bits to get the requesting client device up-to-date. In fact, the second condition does not necessarily require the locking server 122-1-s to store the data file at all.

Continuing with this example, assume each file revision has an associated GUID. The locking server 122-1-s stores the GUID for the latest revision of the file along with the current state of the lock. The lock state information may indicate, for example, whether the file is currently locked, and if so by which client device. If a client device does not yet have this revision it triggers synchronization operations to get this revision from one or more of its peers that have the particular revision, or a central data server (e.g., the data servers 124-1-t) in the absence of available peers. Once the client device is in synchronization then the lock can be granted. When a client has completed a write operation it contacts the locking server 122-1-s to release the lock, and provides a new GUID that represents the current revision of the file. The client device also stores the new GUID along with the revised data file. It is replicated along with the file.

Synchronization operations for data files with different versions may be performed in a number of different ways. For example, synchronization operations may be performed by using binary deltas to gradually update only that information for the data file that has been changed. In another example, synchronization operations may be performed by moving whole files across the network between devices. Presuming a client device is often connected, and synchronization is achieved using binary deltas rather than moving whole files, then the writing client is probably already up to date at the time it needs a write lock, or it could be a relatively quick operation.

When a lock is granted to a client device, then various lock protection schemes may be implemented to make sure the system does not have undesired behavior. In one embodiment, for example, a client device may be arranged to synchronize a modified data file up to a central data server (e.g., the data servers 124-1-t) immediately after it completes a write. This may prevent a scenario from occurring where a client device updates the revision GUID on the locking server 122-1-s, and then immediately dies or goes out of service, thereby preventing other client devices from being able to write to the file because it will be unable to get the current revision before writing. In another embodiment, for example, the locking servers 122-1-s may be arranged to allow a given lock to a data file to expire or time out if not periodically refreshed.

Operations for the network storage system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the network storage system 100 or alternative elements as desired for a given set of design and performance constraints.

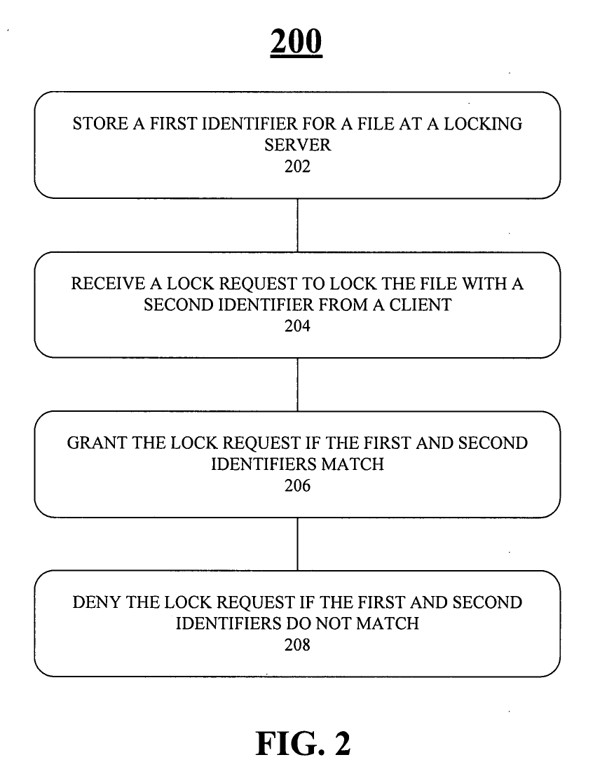

FIG. 2 illustrates a logic flow 200. Logic flow 200 may be representative of the operations executed by one or more embodiments described herein. As shown in FIG. 2, the logic flow 200 may store a first identifier for a file at a locking server at block 202. In some cases, the logic flow 200 may optionally store a lock state and client identifier for the file as well. The logic flow 200 may receive a lock request to lock the file with a second identifier from a client at block 204. The logic flow 200 may grant the lock request if the first and second identifiers match at block 206. If the lock request is granted, then the logic flow 200 may optionally perform a write operation on the file by the client when the file is locked. The logic flow 200 may deny the lock request if the first and second identifiers do not match at block 208. If the lock request is denied, the logic flow 200 may optionally send the client a message to retrieve the file with the first identifier from a data server or another client. The embodiments are not limited in this context.

In one embodiment, for example, a lock may still be denied even if the identifiers match. For example, another client may already have an exclusive lock. Consequently, a determination may be made as to whether an exclusive lock has been granted to another client. If the identifiers match, and there is an exclusive lock granted to another client, then the requested lock may be denied. If the identifiers match, and an exclusive lock has not been granted to another client, then the requested lock may be granted.

If the identifiers do not match, thereby indicating that the requesting client is not up to date and needs to synchronize current file contents before a lock may be granted, it may be useful to make a determination as to whether another client has an exclusive lock already. For example, if the identifiers do not match and there is an exclusive lock granted to another client, then the locking request may be denied to prevent wasted effort in synchronizing the files until a lock request may be granted.

In one embodiment, for example, a third identifier for the file may be received from a client or a data server. The third identifier may represent an identifier for an updated or revised data file, sometimes referred to as a file revision identifier. Since the locking servers 122-1-s manage locking operations for the network storage system 100, the locking servers 122-1-s need to be updated with a GUID for the latest version of a data file. This may be accomplished in various ways. For example, if a client device 102-1-m updates a data file, then the client device 102-1-m sends a GUID indicating the revision to the locking servers 122-1-s. Alternatively, if a client device 102-1-m updates a data file, then the client device 102-1-m sends a GUID indicating the revision to the data servers 124-1-t, and the data servers 124-1-t periodically or aperiodically replicate the updated GUIDs to the locking servers 122-1-s. The latter scenario may be desirable in those cases where the client devices 102-1-m store the latest versions of a data file to a central storage system such as the data servers 124-1-t.

Once a client device has been granted a write lock, and modifies or revises a local version of the data file, the client device may send a lock release request to release the lock for the data file to the locking servers 122-1-s. If the locking servers 122-1-s do not receive a lock release request within a defined time period, the locking servers 122-1-s may expire, time out or release the lock so that other client devices may access the target data file. This may comprise an example of a “forced” lock release by the locking server 122-1-s to recover. In this case the file revision identifier is typically not modified because the locking server 122-1-s may not be able to guarantee that the update was completed, and so the file is effectively reverted and left untouched.

When a locking server 122-1-s receives a lock release request to release the lock from the requesting client device, the locking server 122-1-s may release the lock. The locking server 122-1-s may then receive a third identifier representing a file revision identifier for the file from the requesting client. The file revision identifier will generally be updated on the locking server 122-1-s when the write lock is released, and these should typically occur together atomically and after the file data is written to the data servers 124-1-t.

As previously described, the various embodiments may increase the efficiency and scalability of the network storage system 100 by separating the locking operations and data management operations into different server clusters of the server array 120. For example, this technique allows scaling because bandwidth requirements to the respective server clusters can be lowered. The largest file types (e.g., media files) can be served without requiring traffic to the locking servers 122-1-s at all. In addition, the largest file types can be fulfilled from a more geographically distributed set of replicated data servers or directly from peer clients. Read operations, which comprise most file operations, similarly do not require communication with the data servers 124-1-t. Similarly, write operations require a reduced amount of communication with the locking servers 122-1-s, thereby potentially allowing more bandwidth for communications with the data servers 124-1-t. In another example, the number of locking servers 122-1-s for handling a given set of data files may be relatively few in number, although fast data transfers between them may be needed since granting a lock requires all the locking servers 122-1-s to be notified when a lock is granted. To assist in scaling, the file space may be partitioned and allocated to an appropriate locking server cluster. The file space may be partitioned, for example, by user account. Due to these limitations, individual locking servers for a given file should not be geographically distributed very broadly.

The data servers 124-1-t, however, can be as geographically distributed as desired for a given implementation. File replication among the servers and client peers can be designed to be convergent given the revision identifiers of the files. A client reading from an out-of-date server or client peer will simply view an earlier state. When a write lock is required, however, it will be forced to get up-to-date with the current version before writing. This feature may facilitate scaling operations since most read operations can be directly fulfilled from a peer client, or alternatively, fulfilled from a more geographically distributed set of data servers. As a result, there is less of a bottle neck on centralized server clusters.

The data servers 124-1-t of the server array 120 may also provide other advantages in addition to those previously described. For example, backup and machine state migration may be implemented via the data servers 124-1-t, as does serving peers that are not online at the same time. The data servers 124-1-t, however, do not necessarily need to bear the burden of serving up bits to every client every time a file is accessed. Consequently, network bandwidth can be significantly reduced, and speed of the central storage can be less critical for backup and state migration services. For example, secondary storage or other strategies could be used for media file backup.

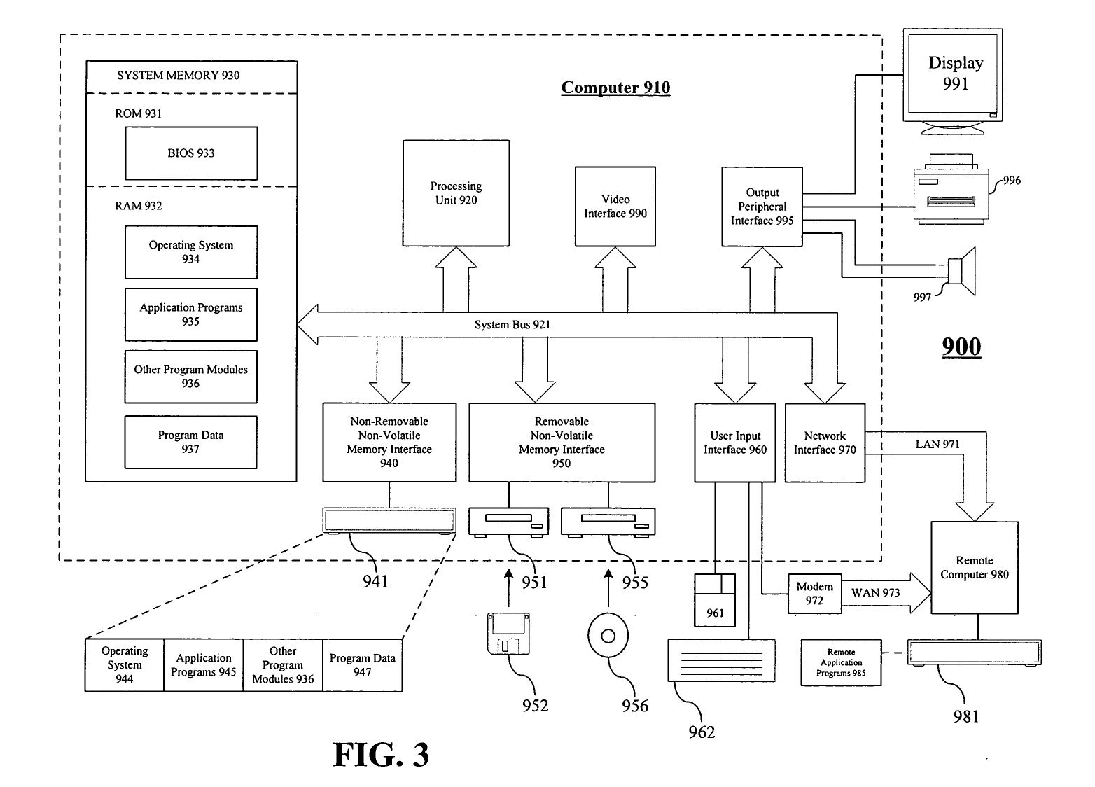

FIG. 3 illustrates a computing system architecture 300. The computing system architecture 300 may represent a general system architecture suitable for implementing various embodiments, such as the client devices 102-1-m, the locking servers 122-1-s, the data servers 124-1-t, and so forth. As shown in FIG. 3, the computing system architecture 300 may include multiple elements, including hardware elements, software elements, or software and hardware elements. Although the computing system architecture 300 as shown in FIG. 3 has a limited number of elements in a certain topology, it may be appreciated that the computing system architecture 300 may include more or less elements in alternate topologies as desired for a given implementation. The embodiments are not limited in this context.

In various embodiments, the computing system architecture 300 typically includes a processing system of some form. In its most basic configuration, the computing system architecture 300 may include a processing system 302 having at least one processing unit 304 and system memory 306. Processing unit 304 may include one or more processors capable of executing software, such as a general-purpose processor, a dedicated processor, a media processor, a controller, a microcontroller, an embedded processor, a digital signal processor (DSP), and so forth. System memory 306 may be implemented using any machine-readable or computer-readable media capable of storing data, including both volatile and non-volatile memory. For example, system memory 306 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information.

As shown in FIG. 3, system memory 306 may store various software programs. For example, the system memory 306 may store one or more application programs and accompanying data. In another example, the system memory 306 may store one or more OS and accompanying data. An OS is a software program that manages the hardware and software resources of a computer. An OS performs basic tasks, such as controlling and allocating memory, prioritizing the processing of instructions, controlling input and output devices, facilitating networking, managing files, and so forth. Examples of a suitable OS for the computing system architecture 300 may include one or more variants of MICROSOFT WINDOWS®, as well as others.

The computing system architecture 300 may also have additional features and/or functionality beyond processing system 302. For example, the computing system architecture 300 may have one or more flash memory units 314. In another example, the computing system architecture 300 may also have one or more input devices 318 such as a keyboard, mouse, pen, voice input device, touch input device, and so forth. In yet another example, the computing system architecture 300 may further have one or more output devices 320, such as a display, speakers, printer, and so forth. In still another example, the computing system architecture 300 may also include one or more communications connections 322. It may be appreciated that other features and/or functionality may be included in the computing system architecture 300 as desired for a given implementation.

In various embodiments, the computing system architecture 300 may further include one or more communications connections 322 that allow the computing system architecture 300 to communicate with other devices. Communications connections may be representative of, for example, the connections 112-1-n. Communications connections 322 may include various types of standard communication elements, such as one or more communications interfaces, network interfaces, network interface cards, radios, wireless transceivers, wired and/or wireless communication media, physical connectors, and so forth. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. The terms machine-readable media and computer-readable media as used herein are meant to include both storage media and communications media.

In various embodiments, the computing system architecture 300 may further include one or more memory units 314. Memory unit 314 may comprise any form of volatile or non-volatile memory, and may be implemented as either removable or non-removable memory. Examples of memory unit 314 may include any of the memory units described previously for system memory 306, as well as others. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously provided for the memory units 306, 314. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
storing a first identifier for a file at a locking server;
receiving a lock request to lock the file with a second identifier from a client;
granting the lock request if the first and second identifiers match; and
denying the lock request if the first and second identifiers do not match.

2. The method of claim 1, comprising sending the client a message to retrieve the file with the first identifier from a data server or another client.

3. The method of claim 1, comprising storing a lock state, client identifier for the file, and a file revision identifier.

4. The method of claim 1, comprising performing a write operation on the file by the client when the file is locked.

5. The method of claim 1, comprising
receiving a lock release request to release the lock;
releasing the lock by the locking server; and
receiving a third identifier representing a file revision identifier for the file from a client.

6. The method of claim 1, comprising receiving a third identifier for the file from a data server.

7. The method of claim 1, comprising receiving a lock release request to release the lock for the file from the client.

8. The method of claim 1, comprising releasing the lock for the file after a defined time period.

9. An article comprising a storage medium containing instructions that if executed enable a system to:
store a first version number for a file at a locking server;
receive a lock request to lock the file with a second version number;
grant the lock request if the first and second version numbers match; and
deny the lock request if the first and second version numbers do not match.

10. The article of claim 9, further comprising instructions that if executed enable the system to send the client a message to retrieve the file with the first version number from a data server or a client device.

11. The article of claim 9, further comprising instructions that if executed enable the system to receive a third version number for the file from a client or a data server.

12. The article of claim 9, further comprising instructions that if executed enable the system to receive a lock release request to release the lock for the file by the locking server.

13. The article of claim 9, further comprising instructions that if executed enable the system to release the lock for the file after a defined time period.

14. The article of claim 9, further comprising instructions that if executed enable the system to store a lock state and client identifier for the file.

15. The article of claim 9, further comprising instructions that if executed enable the system to perform a write operation on the file by a client when the file is locked.

16. An apparatus comprising:
a data server to store multiple data files; and
a locking server to store locking information for one or more data files stored by the data server, the locking information to include a version number for a data file and a lock state for the data file.

17. The apparatus of claim 16, the locking server comprising a server lock manager, the server lock manager to store a first identifier for a data file, receive a lock request to lock the file with a second identifier from a client device, and send a lock request response granting the lock request if the first and second identifiers match and denying the lock request if the first and second identifiers do not match to the client device.

18. The apparatus of claim 16, the locking server comprising a server lock manager, the server lock manager to receive a lock request to lock a data file from a client device with an identifier, and send a lock request response to the client device to retrieve an updated version of the data file based on the identifier.

19. The apparatus of claim 16, comprising a client device to communicate with the locking server, the client device comprising:
a database to store a local version of a data file; and
a cache manager to manage the local version of the data file, the cache manager having a client lock manager to send a lock request to lock the data file with an identifier for the data file to the locking server, and receive a lock request response granting the lock request or denying the lock request based on the identifier from the locking server.

20. The apparatus of claim 16, comprising a client device to communicate with the locking server, the client device comprising a synchronization engine to synchronize a local version of a data file with a server version of the data file stored by the data server, or another local version of the data file with another client device in response to instructions received from the locking server.
